(19) United States
(12) Patent Application Publication
(10) Pub. No.: US 2014/0202792 A1
(43) Pub. Date: Jul. 24, 2014

(54) LIFT FOR ALL TERRAIN VEHICLES

(71) Applicant: ALGER E. STONEBURNER, JR., OWINGS, MD (US)

(72) Inventor: ALGER E. STONEBURNER, JR., OWINGS, MD (US)

(21) Appl. No.: 14/194,645

(22) Filed: Feb. 28, 2014

Related U.S. Application Data
(60) Provisional application No. 61/755,854, filed on Jan. 23, 2013.

(51) Int. Cl. B66F 11/04; A01M 31/02; E04G 1/22; E04G 1/24

(52) U.S. Cl. CPC B66F 11/04; E04G 1/24; A01M 31/02; E04G 1/22; E04G 2001/244
USPC 182/69.4

(57) ABSTRACT

The lift for all terrain vehicles has a plurality of telescoping box-shaped frame members, each frame member having top and bottom rectangles made of square tubing, the rectangles being spaced apart by posts at each of the corners. The inner telescoping box-shaped member has a standing platform mounted on the bottom rectangle. A plurality of telescopic support and leveling legs are attached to the outer telescoping box-shaped member. The legs, when extended, provide stability when raising and lowering the standing platform. A plurality of vertically disposed elongated legs extend from the outer telescoping generally box-shaped member, and are adapted for attachment to an ATV or other vehicle.

### CROSS-REFERENCE TO RELATED APPLICATION

This application claims the benefit of U.S. Provisional Patent Application Ser. No. 61/755,854, filed Jan. 23, 2013.

### FIELD OF THE INVENTION

The present invention relates to platforms, scaffolds, hunter's stands, and the like, and more particularly to a lift for all terrain vehicles that provide a vehicle-mounted telescopic platform for homeowners, hunters, construction workers, and the like that can be mounted on an all-terrain vehicle (ATV), pickup truck, or other off-road vehicle.

### DESCRIPTION OF THE RELATED ART

The relatively easy access to areas now provided by all-terrain vehicles (ATVs) has encouraged the development of stands that can be mounted on ATVs. Most common among these stands are hunting stands for all terrain vehicles. These stands are not portable and are partially supported by the vehicle. Such stands often must abut a tree for further support. These stands are unsuitable for use in flatlands or in areas where a forest has been harvested, since no trees are available to support the stand.

Additionally, these stands are not easily used by a homeowner trying to get a house painted on a ladder or a worker trying to get to an area that a truck cannot go because of the terrain. Most construction jobs or homeowner jobs in non-major cities only require a ladder or platform to reach twenty feet. Many homeowners, hunters, and workers have ATVs that are underutilized, and sitting in a garage or storage because there is no further use for the ATV after riding up and down the terrain. The homeowner is constantly trying to use the ATV for work around the house. The worker searches for a way to not have to use expensive, non-movable scaffolding for jobs at a height of twenty feet or less. The hunter seeks a hunting stand that does not require a tree for support and that can be raised and lowered to different heights.

Thus, a lift for all terrain vehicles solving the aforementioned problems is desired.

### SUMMARY OF THE INVENTION

The lift for all terrain vehicles has a plurality of telescoping box-shaped frame members, each frame member having top and bottom rectangles made of square tubing, the rectangles being spaced apart by posts at each of the corners. The inner telescoping box-shaped member has a standing platform mounted on the bottom rectangle. A plurality of telescopic support and leveling legs are attached to the outer telescoping box-shaped member. The legs, when extended, provide stability when raising and lowering the standing platform. A plurality of vertically disposed, elongated legs also extend from the outer telescoping box-shaped member, and are adapted for attachment to an ATV or other vehicle.

These and other features of the present invention will become readily apparent upon further review of the following specification and drawings.

### BRIEF DESCRIPTION OF THE DRAWINGS

FIG. 1 is an environmental, perspective view of a lift for all terrain vehicles according to the present invention, shown attached to an All-Terrain Vehicle 12.

FIG. 2 is an environmental front view of the lift for all terrain vehicles of FIG. 1, according to the present invention.

FIG. 3 is an environmental side view of the lift for all terrain vehicles of FIGS. 1 and 2, according to the present invention.

FIG. 4 is an environmental, perspective view of another embodiment of a lift for all terrain vehicles, according to the present invention, shown attached to an All-Terrain Vehicle 12.

Similar reference characters denote corresponding features consistently throughout the attached drawings.

### DETAILED DESCRIPTION OF THE PREFERRED EMBODIMENTS

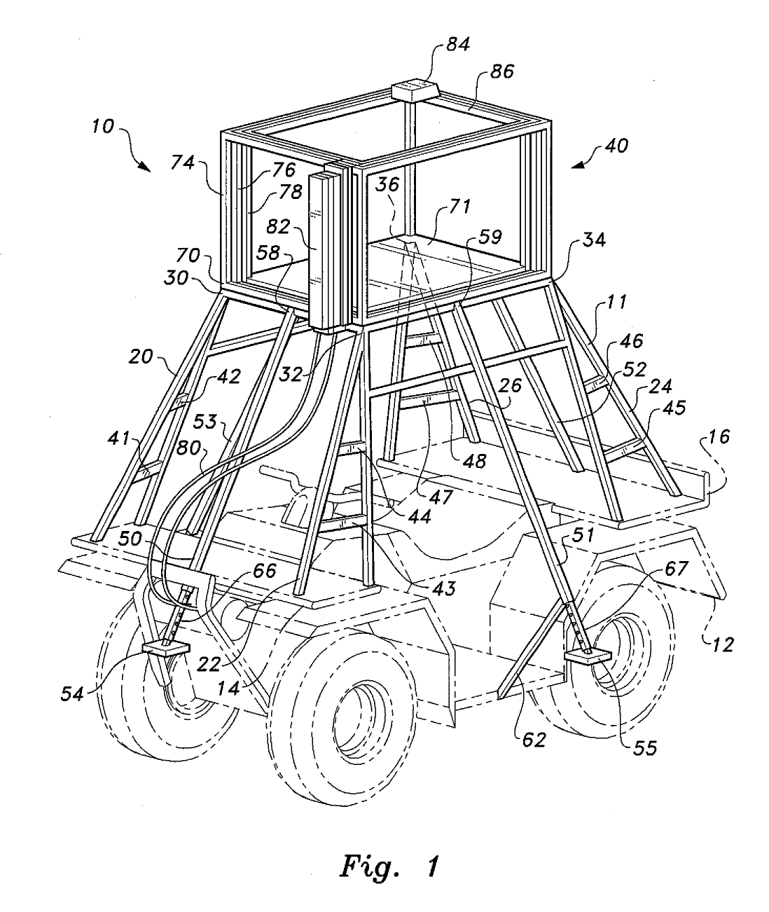

As shown in FIGS. 1-3, the lift for All-Terrain Vehicles, hereinafter “ATV,” can be a lifting platform, generally indicated by the number 10, adapted for mounting on an ATV 12 or other vehicle. The ATV lift 10 can be an all-aluminum, telescoping, framed lifting platform 11 that may be removably attached, e.g., to a front cargo rack 14 and a rear cargo rack 16 on the ATV 12. The all-aluminum construction can be either a round tube or a square tube stock aluminum. As shown, four legs 20, 22, 24, 26 are attachable to the lift 10 to the ATV 12, however, it is contemplated that additional legs (more than four) can be attached between the lift 10 and ATV 12, to provide additional stability. The legs 20, 22 are attachable to the front cargo rack 14 and legs 24, 26 are attachable to the rear cargo. As such, the attachment points swivel as four-point universal joints to allow for attachment to most ATV cargo racks, both front 14 and back 16. The cargo rack attachment legs 20, 22, 24, 26 are A-frame legs with their respective apices 30, 32, 34, and 36 attached to an extendable, generally boxed-shaped platform, generally indicated by the number 40. Each of the cargo rack attachment legs 20, 22, 24, 26 can have at least two respective crossmembers 41, 42, 43, 44, 45, 46, 47, 48. The crossmembers 41, 42, 43, 44, 45, 46, 47, 48 are generally parallel to each other and connect each of the respective individual legs of the A-frames of the cargo rack attachment legs 20, 22, 24, 26, the second crossmember of each A-frame leg providing additional support for the cargo rack attachment legs 20, 22, 24, 26.

Once the ATV lift 10 is ready for use, ground support and leveling legs 50, 51, 52, 53 can be lowered to a ground level to provide stability. The ground support legs 50, 51, 52, 53 are telescopic, and are easily extended for use and retracted for travel. The legs 50, 51, 52, and 53 extend at a predetermined angle from the extendable boxed-shaped platform 40. Each of the respective ground support and leveling legs 50, 51, 52, 53 include a pad 54, 55, 56, 57 that adjustably extend generally from the lower end of each of the legs. The pads 54, 55, 56, 57 are generally square and extend outside a footprint formed by the ATV 12 or exterior of the ATV 12. The four ground support and leveling legs 50, 51, 52, 53 attach at one end to the bottom of the extendable generally boxed-shaped platform 40, between the apices 30, 32, 34, 36 at support leg contact points 58, 59, 60, 61. Two of the four support and leveling legs 51, 53 include braces 62, 64 that help absorb some of the weight of the ATV lift 10 against the ATV 12. The other two legs 50, 52 are attached to the cargo racks 14, 16. Thus, the load support is divided between ATV cargo racks 14, 16 and the ground support and leveling legs 50, 51, 52, 53.

The ground support and leveling legs 50, 51, 52, 53 also perform an additional function in that they provide stability to the ATV lift 10 and to the generally boxed-shaped platform 40. Each of the support and leveling legs 50, 51, 52, 53, when extended, can be locked into place with a final leveling adjustment. The last approximately twenty-four inches of each of the legs 50, 51, 52, 53 utilizes a pushpin mechanism, generally indicated with numbers 66, 67, 68, 69 that have through-holes in the legs 50, 51, 52, 53 near the pads 54, 55, 56, 57, and a push pin is inserted into the holes of each to lock them in place.

After the support and leveling legs 50, 51, 52, 53 are lowered, the pads 54, 55, 56, 57 are moved into position and locked into place with the pushpin mechanisms 66, 67, 68, 69. At this point, the ATV lift 10 is stabilized on and around the ATV 12. The extendable generally boxed-shaped platform 40 is ready to use. As such, the platform 40 can be telescoped or raised to a height of approximately twenty feet from the ground, including the height of the ATV 12, at four-foot intervals. The platform 40 can lift at intervals of four feet with the collapsed height being eight feet from the ground, including the height of the ATV 12, to a base area 70 where a standing floor 71 is initially positioned.

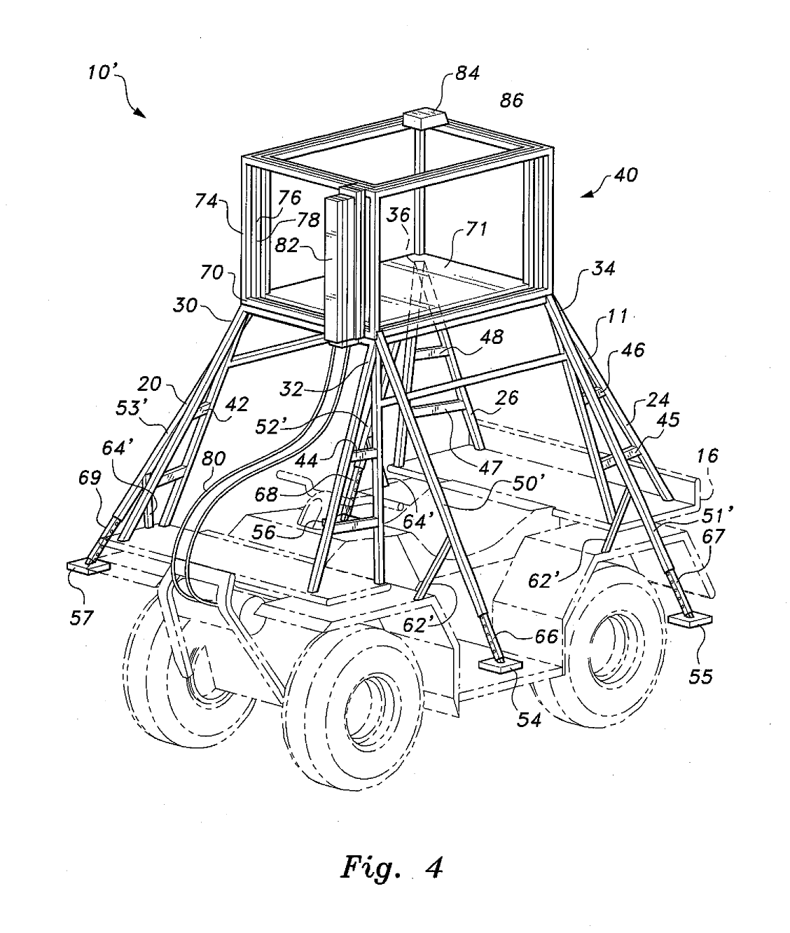

The arrangement of the support and leveling legs 50, 51, 52, 53 within the frame can be varied to provide the desired or required support. For example, the embodiment shown in FIGS. 1-3 provide that the support and leveling legs 50, 51, 52, 53 extend from the sides of the box-like frame, i.e. front, back, and opposite lateral sides. This is adequate in most situations, but occasionally users may experience difficulty with ingress and egress in and out of the ATV 12 due to the disposition of the support and leveling legs 50, 51, 52, 53. In order to compensate for those situations and similar, FIG. 4 shows an embodiment of an ATV lift 10′ in which the corresponding support and leveling legs 50′, 51′, 52′, 53′ have been repositioned so they extend from the corners of the frame. It is noted that in the embodiment shown by ATV lift 10′, only the variations have been designated by a different reference number. The above arrangement provides substantially the same stability and support without compromising user access to the ATV 12. Additionally, one or more of the support and leveling legs 50′, 51′, 52′, 53′ can be provided with corresponding braces 62′, 64′ to support and buttress the angular extension of the support and leveling legs 50′, 51′, 52′, 53′ with respect to the body of the ATV 12.

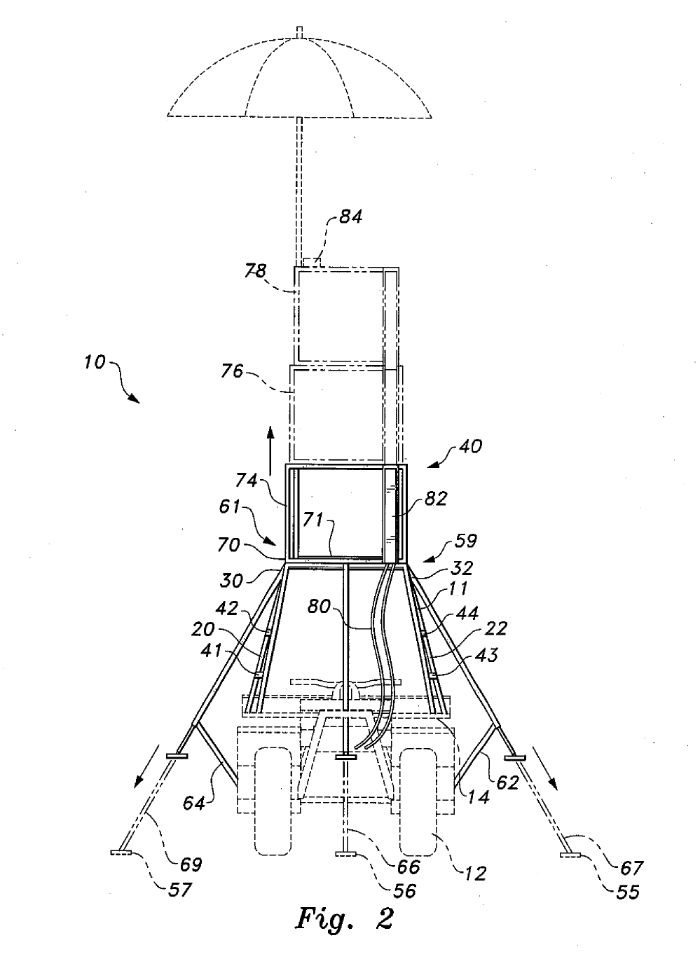

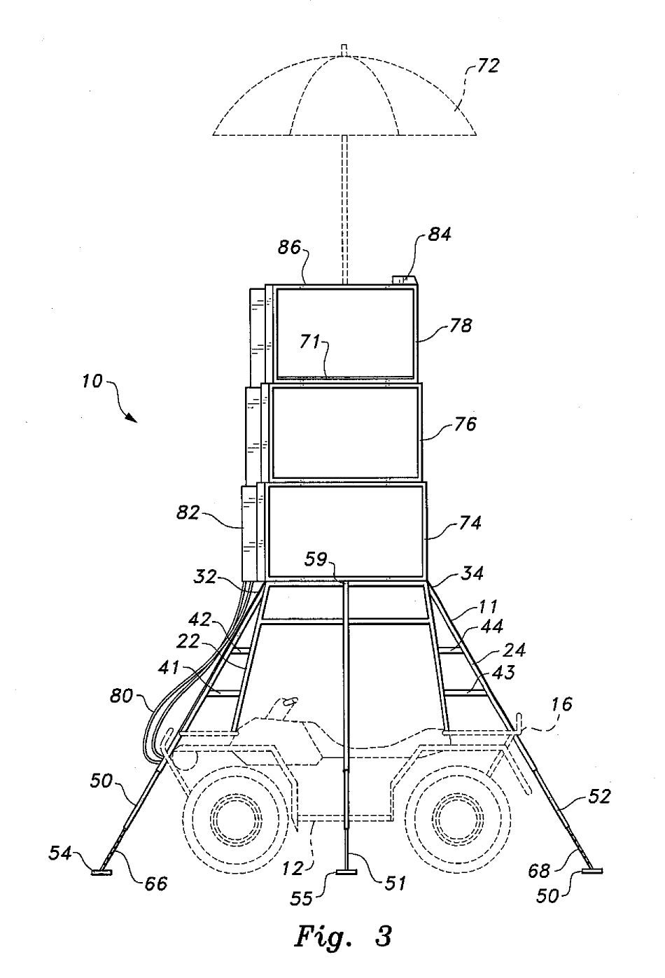

The standing floor 71 can be platform for standing and can be about four feet by four feet. There is room for tools, paint, hunting equipment, camera equipment, or other suitable type of equipment to be used outdoors. Of course, the floor 71 can also be used with a chair and an optional umbrella 72 may be attached to provide shade, as shown in FIGS. 2 and 3.

Around the standing floor 71 are three generally box-shaped frames 74, 76, 78. These box-shaped frames 74, 76, 78 are made of the same tubular material as the other parts of the ATV lift 10. Each box-shaped member is a frame formed from two rectangles made from square tubing that are joined at the corners by four posts that separate or space the rectangles apart. The members 74, 76, 78 are telescopic in construction, so that an initial position is about twelve feet in height when the standing floor 71 is at the lowest level, so that the frames 74, 76, 78 will be collapsed inside of each other, as shown in FIG. 1, with the outer box-shaped frame 74 surrounding the other two. At the middle or sixteen-foot level, the outer box-shaped frame 74 supports the other two, with the inner box-shaped frame 78 disposed inside of the middle boxed-shaped frame 76. The floor 71 is only attached to and moves with the inner box-shaped frame 78. Finally, at the top or twenty-foot level, the outer box-shaped frame 74 supports the middle boxed-shaped frame 76 that, in turn, supports the inner box-shaped frame 78. Again, the floor 71 is only attached to and moves with the inner box-shaped frame 78. FIG. 1 illustrates the lowest level, FIG. 2 illustrates the potential movement of the boxed-shaped frames 74, 76, 78, and FIG. 3 illustrates the fully extended height of the ATV lift 10. Thus, the total platform lift heights are approximately twelve feet, sixteen feet, and twenty feet.

A mechanism, such as a cable 80 from a winch and pulley system 82 can be used to raise and lower the telescoping box frames 74, 76, and 78. Controls 84 for the winch and pulley system 82 are located on a rail 86 of the inner box-shaped frame 78. Alternatively, the telescoping box frames 74, 76, and 78 may be raised and lowered by a mechanism such as hydraulic cylinders driven by a hydraulic pump powered by the engine of the ATV 12, or by pneumatic cylinders driven by an air compressor powered by the ATV engine. The lifting member may be steel cable or a steel chain driven by the winch found on most ATVs. Of course, a hand winch can also be used, and a rope ladder can be available for emergency use.

It should be understood that the ATV lift 10 could be adjusted to fit other vehicles, rather than just an ATV. For example, a pick-up truck can be fitted with the ATV lift 10 in the bed of the truck. The ATV lift 10 can also be utilized in marine vessels in situations where elevated positioning of the user is desired, e.g., fishing. As a further alternative, the ATV lift 10 can utilize a variety of pulley/winch systems or linear actuators to facilitate telescoping operation of the box frames 74, 76, and 78 with power supplied integrally from the ATV or other vehicle upon which the ATV lift 10 is mounted or an independent power source.

It is to be understood that the present invention is not limited to the embodiments described above, but encompasses any and all embodiments within the scope of the following claims.

I claim:

1. A lift for all terrain vehicles, comprising:
an extendable platform, the extendable platform a plurality of telescoping box-shaped frames, including an outer frame and at least one inner frame telescoping with respect to the outer frame;
a standing floor mounted on the at least one inner frame;
a mechanism for raising and lowering the telescoping box-shaped frames;
a plurality of vehicle-engaging legs attached to the outer box-shaped frame, the vehicle engaging legs being adapted for mounting on a vehicle; and
a plurality of ground-engaging legs extending from the outer frame;
to wherein the extendable platform is adapted for mounting above the vehicle.

2. The lift for all terrain vehicles according to claim 1, wherein said at least one inner frame comprises at least two inner frames, one of the at least two inner frames being nested within the other, the one of the at least two inner frames having the standing floor mounted thereon.

3. The lift for all terrain vehicles according to claim 2, further comprising an umbrella selectively coupled to the one of the at least two inner frames.

4. The lift for all terrain vehicles according to claim 1, wherein the mechanism for raising and lowering the telescoping box-shaped frames comprises a winch and pulley system coupled to the plurality of telescoping box-shaped frames and a control operatively connected to the winch and pulley system to selectively raise and lower the box-shaped shaped frames.

5. The lift for all terrain vehicles according to claim 1, wherein the plurality of vehicle-engaging legs each comprises a substantially A-frame leg having an apex at one end connected to the extendable platform and the other end adapted for detachable mounting to the vehicle, the A-frame leg having at least one crossmember to brace and provide support.

6. The lift for all terrain vehicles according to claim 5, further comprising universal attachment points on the vehicle-engaging legs to adjustably mount the vehicle-engaging legs onto the vehicle.

7. The lift for all terrain vehicles according to claim 1, wherein the plurality of ground-engaging legs each comprises a substantially elongate member and a pad adjustably extending therefrom to a select position, the pad bracing and supporting the lift for all terrain vehicles with respect to the ground.

8. The lift for all terrain vehicles according to claim 7, further comprising a push-pin mechanism for each pad, the push-pin mechanism locking the corresponding pad in the select position.

9. The lift for all terrain vehicles according to claim 8, wherein the plurality of ground-engaging legs extend from the sides of the extendable platform.

10. A lift for vehicles, comprising:
an extendable platform, the extendable platform having a plurality of telescoping box-shaped frames;
a standing floor mounted on one of the plurality of telescoping box-shaped frames;
a mechanism for selectively raising and lowering the telescoping box-shaped frames;
a plurality of vehicle-engaging legs extending from the extendable platform, the vehicle engaging legs being adapted for mounting on a vehicle; and
a plurality of ground-engaging legs extending from the extendable platform;
wherein the extendable platform is adapted for mounting above the vehicle.

11. The lift for vehicles according to claim 10, wherein the plurality of telescoping box-shaped frames comprises an outer frame and at least one inner frame telescoping with respect to the outer frame.

12. The lift for vehicles according to claim 11, wherein said at least one inner frame comprises at least two inner frames, one of the at least two inner frames being nested within the other, the one of the at least two inner frames having the standing floor mounted thereon.

13. The lift for vehicles according to claim 10, wherein the mechanism for selectively raising and lowering the telescoping box-shaped frames comprises a winch and pulley system coupled to the plurality of telescoping box-shaped frames and a control operatively connected to the winch and pulley system in order to selectively activate the winch and pulley system to raise and lower the box-shaped shaped frames.

14. The lift for vehicles according to claim 10, wherein the plurality of vehicle-engaging legs each comprises an A-frame leg having an apex at one end connected to the extendable platform and the other end adapted for detachable mounting to the vehicle, the A-frame leg having at least one crossmember to brace and provide support.

15. The lift for all terrain vehicles according to claim 10, wherein the plurality of ground-engaging legs each comprises a substantially elongate member and a pad adjustably extending therefrom to a select position, the pad bracing and supporting the lift for all terrain vehicles with respect to the ground.

16. The lift for all terrain vehicles according to claim 15, further comprising a push-pin mechanism for each pad, the push-pin mechanism locking the corresponding pad in the select position.

17. The lift for all terrain vehicles according to claim 16, wherein the plurality of ground-engaging legs extend from the sides of the extendable platform.
